(19) United States
(12) Patent Application Publication
(10) Pub. No.: US 2017/0316372 A1
(43) Pub. Date: Nov. 2, 2017

(54) Systems and Methods for Inventory Management of Retail Products

(71) Applicant: Wal-Mart Stores, Inc., Bentonville, AR (US)

(72) Inventors: John P. Thompson, Bentonville, AR (US); Robert C. Taylor, Rogers, AR (US)

(21) Appl. No.: 15/499,142

(22) Filed: Apr. 27, 2017

Related U.S. Application Data
(60) Provisional application No. 62/328,278, filed on Apr. 27, 2016.

(51) Int. Cl. G06Q 10/08; G06Q 10/10; G06F 17/30; G06K 7/10; H04L 29/08; G08B 21/18

(52) U.S. Cl. CPC G06Q 10/087; H04L 67/18; G08B 21/182; G06F 17/30312; G06K 7/10009; G06Q 10/1097

(57) ABSTRACT

Systems, apparatuses and methods are provided herein for inventory management of retail products in a retail facility. A system for inventory management comprises: a motion sensor configured to detect motion in proximity to the one or more retail products; a location transmitter for transmitting a location of a store worker; a database; an alerting device for alerting the store worker to shelf inventory levels; and a control circuit configured to determine that a store worker is in proximity to the one or more retail products, determine that a shelf inventory level of the one or more retail products is below a predetermined threshold, and cause the alerting device to alert the store worker in proximity to the one or more retail products that the shelf inventory level of the one or more retail products is below the predetermined threshold.

### RELATED APPLICATION

This application claims the benefit of U.S. Provisional Application No. 62/328,278, filed Apr. 27, 2016, which is incorporated herein by reference in its entirety.

### TECHNICAL FIELD

The field of this invention relates generally to inventory management of retail products in a retail facility. In particular, the present invention relates to systems and methods for inventory management of retail products in a retail facility useful in identifying stocking levels.

### BACKGROUND

In modern retail environments, there is a need to consistently maintain an adequate shelf inventory of retail products. As customers select items from a shelf for purchase, the shelf inventory is reduced. During peak or otherwise busy periods in the store, shelf inventory may quickly become reduced to the point that there is not enough of a specific retail product on the shelf to satisfy customers' needs. In many cases, store workers working in the area may be unaware of the reduced shelf inventory until alerted by a customer. Alternatively, a store worker may become aware of reduced shelf inventory when the worker walks directly in front of the shelf and can see the shelf inventory level for themselves. However, even when walking by a shelf, a busy store or otherwise distracted worker may not notice a reduced shelf inventory.

### BRIEF DESCRIPTION OF THE DRAWINGS

Disclosed herein are embodiments of systems, apparatuses and methods pertaining to inventory management in a retail facility, e.g., by alerting store workers to low shelf inventory conditions in the retail facility. This description includes drawings, wherein:

FIG. 1 is a block diagram of a system in accordance with several embodiments.

FIG. 2 is a flow diagram of a method in accordance with several embodiments.

FIG. 3 is an illustration of an area of a retail facility in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful for inventory management in a retail facility. Embodiments may include a control circuit communicatively coupled to a motion sensor, a location transmitter for transmitting a location of a store worker, an alerting device for alerting the store worker to shelf inventory levels, and a database for storing at least one of inventory data, sales data, motion sensor data, location transmitter data, and store worker profiles. The motion sensor may be positioned in a predetermined location in proximity to one or more retail products in a shopping area and may be configured to detect motion in proximity to the one or more retail products.

In some embodiments, the control circuit may be configured to determine that a store worker is in proximity to the one or more retail products, to determine that a shelf inventory level of the one or more retail products is below a predetermined threshold, and to cause the alerting device to alert the store worker in proximity to the one or more retail products that the shelf inventory level of the one or more retail products is below the predetermined threshold. In some embodiments, the control circuit may determine that a store worker is in proximity to the one or more retail products by obtaining last known locations of one or more store workers in the shopping area, and identifying a store worker having a last known location within a predetermined distance to at least one of the location of the motion sensor and the location of the one or more retail products.

In some embodiments, the alerting device may comprise a lighting device positioned at a location adjacent the one or more retail products, the lighting device being configured to alert the store worker by displaying a light signal when the shelf inventory level of the one or more retail products is below the predetermined threshold. In some embodiments, the alerting device may comprise a handheld device configured to be carried by the store worker. The handheld device may be configured to display the shelf inventory level of the one or more retail products having a shelf inventory level below the predetermined threshold. In some embodiments, the handheld device may include the location transmitter for transmitting the location of the store worker carrying the handheld device.

In some embodiments, the location transmitter may be configured to emit a radio frequency identification (RFID) signal and the motion sensor may be configured to detect an RFID signal and to transmit to the control circuit the RFID signal from a location transmitter that is within the predetermined distance to the motion sensor. The control circuit may determine that a store worker is in proximity to the one or more retail products by associating the RFID signal with a store worker in the shopping area.

Some embodiments may include one or more shelf inventory sensors for detecting the shelf inventory level of the one or more retail products. In such a case, the control circuit may determine that the shelf inventory level of the one or more retail products is below the predetermined threshold based on data obtained from the one or more shelf inventory sensors. In some embodiments, the control circuit may determine that the shelf inventory level of the one or more retail products is below the predetermined threshold by comparing a number of retail products previously shelved to at least one of a number of retail products sold and a number of retail products in stock.

In some embodiments, the control circuit may be configured to automatically create a task in a task scheduling system to replenish the shelf inventory level of the one or more retail products below having a shelf inventory level below the predetermined threshold.

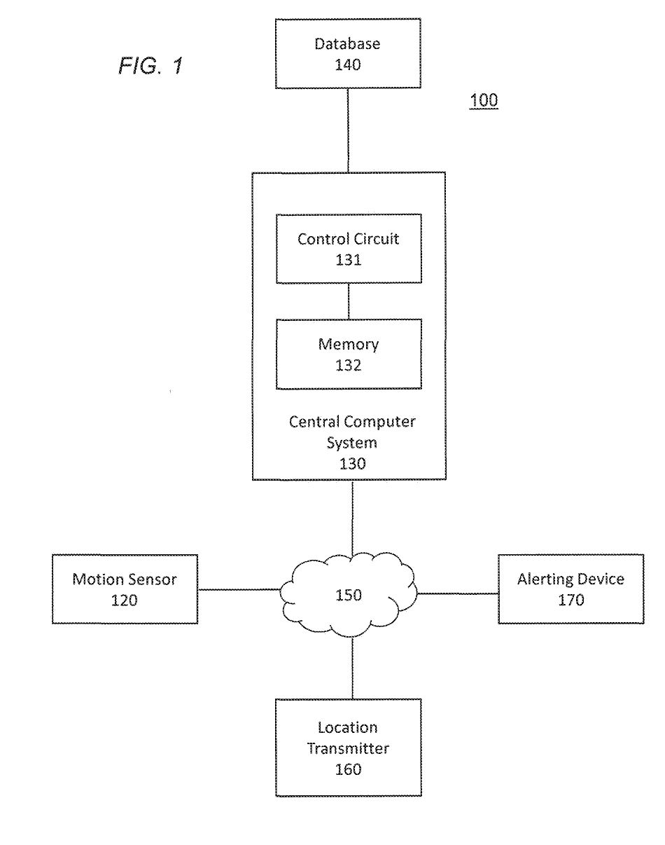

FIG. 1 illustrates an embodiment of a system for inventory management. The system 100 includes a central computer system 130, a motion sensor 120, a location 160 transmitter, and an alerting device 170. The central computer system 130 may be directly or indirectly communicatively coupled with the motion sensor 120, location transmitter 160, and alerting device 170 through one or more wired and/or wireless distributed communication networks 180 (e.g., LAN, WAN, Internet, etc.).

The system typically further includes at least one database 140 and/or other electronic data storage components, which may store inventory data, sales data, motion sensor data, location transmitter data, store worker profiles, product information, and/or other such information. Database 140 generally comprises volatile and/or non-volatile computer readable storage memory device(s) and be directly or indirectly communicatively coupled with the central computer system 130 through one or more wired and/or wireless distributed communication networks 180 (e.g., LAN, WAN, Internet, etc.). While the database 140 is shown as a separate component from the memory 132 of the central computer system 130 in FIG. 1, in some embodiments, the database 140 and the memory 132 may be implemented with the same one or more memory devices. In some embodiments, the system may optionally include and/or communicatively couple with one or more point-of-sale (POS) systems, one or more inventory systems, one or more task systems, and other relevant systems.

The motion sensor 120 may be configured to detect motion from an approaching person using any active or passive motion sensing technology, such as, for example, infrared, ultrasonic, microwave, and combinations thereof. The motion sensor 120 may be positioned in any location in proximity to one or more retail products in a shopping area. For example, the motion sensor 120 may be installed in the celling, pillars, beams, modules, display shelves, etc. of a retail facility.

The location transmitter 160 may comprise any device or component that may emit a detectable signal and/or otherwise transmit a location of the device associated with a store worker to a detection component. In some embodiments, the location transmitter 160 may comprise a geolocation and/or global positioning component in a handheld device that transmits the location of the handheld device to the central computer system 130. The handheld device may comprise, for example, a personal computer, a laptop computer, or a handheld communication device such as a mobile phone or tablet or the like.

In some embodiments, the location transmitter 160 may be configured to emit a radio frequency identification (RFID) signal that may be detected by a detection component. In some embodiments, the motion sensor 120 may be further configured to detect an RFID signal and to transmit to the central computer system 130 the RFID signal obtained from the location transmitter 160 that is within the predetermined distance to the motion sensor. In such a case, the central computer system 130 may determine that a store worker is in proximity to the one or more retail products by associating the RFID signal with a store worker in the shopping area.

The alerting device 170 may be positioned adjacent the one or more retail products and may comprise, for example, a lighting device configured to alert the store worker by displaying a light signal when the shelf inventory level of the one or more retail products is below the predetermined threshold. The lighting device may be configured to emit any color or wavelength of visible light when the shelf inventory is below the predetermined threshold. In some embodiments, the lighting device may emit different colors or wavelengths of light based on the estimated shelf inventory in proximity to the lighting device. For example, the lighting device may emit a yellow light when the shelf inventory is below the predetermined threshold and may emit red light when the shelf inventory has been completely depleted and/or when there is no additional inventory available to replenish the shelf inventory. In some embodiments, the lighting device may emit a continuous light when the shelf inventory is below the predetermined threshold. In other embodiments, the lighting device may emit a flashing light when the shelf inventory is below the predetermined threshold.

In some embodiments, the alerting device 170 may comprise a handheld device configured to be carried by the store worker. The handheld device may comprise any mobile electronic device that may be carried by a store worker. For example, the handheld device may comprise a personal computer, a laptop computer, or a handheld communication device such as a mobile phone or tablet or the like. The handheld device may be configured to alert the store worker to the presence of low shelf inventory by emitting a continuous or flashing light in response to shelf inventory levels, as described above for the lighting device. In other embodiments, the handheld device may alert the worker by using an audio or vibrating alert. For example, the handheld device may be configured to emit a specific pattern of vibration or sound, or a specific audio tone and/or frequency to alert the store worker to the presence of low shelf inventory. In some embodiments, the handheld device may be configured to display a text message alerting the store worker to low shelf inventory levels. In some embodiments, the handheld device may be configured to display the actual or estimated shelf inventory level of one or more retail products having a shelf inventory level below the predetermined threshold and/or may be configured to display instructions for the store worker regarding how to respond. In some embodiments, the handheld device may include the location transmitter for transmitting the location of the store worker carrying the handheld device. For example, the handheld device may include both an alerting component and a geolocation and/or global positioning component that transmits the location of the handheld device to the central computer system 130.

The central computer system 130 may include a control circuit 131 and a memory 132 and may generally be any processor-based device such as one or more of a computer system, a server, a networked computer, a cloud-based server, etc. The control circuit 131 may comprise a central processing unit, a processor, a microprocessor, and the like. The control circuit 131 may be configured to execute computer readable instructions stored on the memory 132. The memory 132 may comprise volatile and/or non-volatile computer readable storage memory and have stored upon it a set of computer readable instructions which, when executed by the control circuit 131, causes the system to determine that a store worker is in proximity to one or more retail products, determine that a shelf inventory level of the one or more retail products is below a predetermined threshold, and alert the store worker in proximity to the one or more retail products that the shelf inventory level is below the predetermined threshold.

In some embodiments, the central computer system 130 may be configured to determine that a store worker is in proximity to the one or more retail products by obtaining last known locations of one or more store workers in the shopping area and identifying a store worker having a last known location within a predetermined distance to at least one of the location of the motion sensor and the location of the one or more retail products. For example, when motion is detected by the motion sensor 120, the central computer system 130 may be triggered to obtain last known locations of store workers. Last known locations of store workers may be, for example, the last location from which a geolocation and/or global positioning signal was transmitted from a from a worker's location transmitter 160. In some embodiments, the last known location of store workers may be estimated based on the most recent product scans performed by store workers using a handheld device assigned to each worker. In some embodiments, the last known or estimated locations of store workers may be stored, for example, in database 140.The central computer system 130 may compare the last known or estimated locations of the store workers and identify a store worker in proximity to the motion sensor and/or the one or more retail products.

In embodiments where the location transmitter 160 is configured to emit a radio frequency identification (RFID) signal which is detected by the motion sensor 120 and transmitted to the central computer system 130, the central computer system 130 may be configured to determine that a store worker is in proximity to the one or more retail products by associating the RFID signal with a specific store worker in the shopping area. For example, when a store worker approaches the an area of the store having shelf inventory of one or more retail products, a motion sensor in proximity to the one or more retail products may detect motion of the approaching store worker and/or may detect an RFID signal being emitted from an RFID transmitter carried by the store worker. The motion sensor 120 may then transmit the RFID signal to the central computer system 130, which correlates the RFID data with a specific store worker to determine that the store worker is in proximity to the motion sensor and/or the one or more retail products

In some embodiments, the central computer system 130 may determine that the shelf inventory level of the one or more retail products is below the predetermined threshold by comparing data obtained from various inventory systems, which may be stored in a database such as, for example, database 140. In some embodiments, the central computer system 130 may compare the number of retail products previously shelved to at least one of the number of retail products sold and the number of retail products in stock. For example, the central computer system 130 may obtain point of sale data for a specific retail item and determine that the number of units sold is approaching the number of units previously shelved for a specific time period. The central computer system 130 may also determine whether or not there is additional inventory available to replenish the shelf inventory.

In some embodiments, the system may further comprise one or more shelf inventory sensors communicatively coupled with the central computer system 130. The shelf inventory sensors may comprise any sensor capable of detecting and/or determining the shelf inventory level of the one or more retail products, such as, for example, load sensors and/or weight sensors. The shelf inventory sensors may be located anywhere on a shelf or module upon which one or more retail items are displayed for purchase. The central computer system 130 may determine that the shelf inventory level of the one or more retail products is below the predetermined threshold based on data obtained from the one or more shelf inventory sensors. In some embodiments, the shelf inventory sensors may be configured to transmit real time data regarding shelf inventory levels to the central computer system 130. In some embodiments, shelf inventory data may be stored in a database, such as database 140

In some embodiments, the central computer system 130 may be further configured to automatically create a task in a task scheduling system to replenish the shelf inventory level of the one or more retail products below having a shelf inventory level below the predetermined threshold.

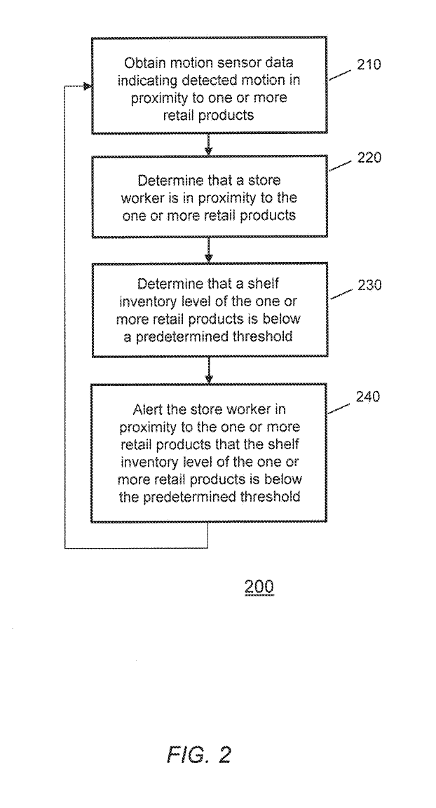

Referring now to FIG. 2, a method for inventory management in a retail facility is shown. Generally, the method shown in FIG. 2 may be implemented with a processor based device such as a control circuit, a central processor, and the like. In some embodiments, the method shown in FIG. 2 may be implemented with the central computer system 130 in FIG. 1.

In step 210, the system obtains motion sensor data from a motion sensor, indicating detected motion in proximity to one or more retail products. In some embodiments, the motion sensor may comprise motion sensor 120 described with reference to FIG. 1. The motion sensor may be configured to detect motion from an approaching person using any active or passive motion sensing technology, such as, for example, infrared, ultrasonic, microwave, and combinations thereof. The motion sensor may be positioned in any location in proximity to one or more retail products in a shopping area. For example, the motion sensor may be installed in the celling, pillars, beams, modules, display shelves, etc. of a retail facility.

The detection of motion in step 210 triggers step 220, where the system determines that a store worker is in proximity to the one or more retail products. This step allows the system to distinguish between motion detected from customers and motion detected from store workers. In some embodiments, the system may obtain location data from location transmitters associated with store workers. In some embodiments, the location transmitter may comprise location transmitter 160 described with reference to FIG.1. In some embodiments, the location data may be stored in a database, such as database 140 described with reference to FIG. 1. The location transmitter may comprise any device or component that may emit a detectable signal and/or otherwise transmit a location of the device associated with a store worker to a detection component. In some embodiments, the location transmitter may comprise a geolocation and/or global positioning component in a handheld device that transmits the location of the handheld device to the system. The handheld device may comprise, for example, a personal computer, a laptop computer, or a handheld communication device such as a mobile phone or tablet or the like.

The system may be configured to determine that a store worker is in proximity to the one or more retail products by obtaining last known locations of one or more store workers in the shopping area and identifying a store worker having a last known location within a predetermined distance to at least one of the location of the motion sensor and the location of the one or more retail products. For example, when motion is detected by the motion sensor, the system may be triggered to obtain last known locations of store workers. Last known locations of store workers may be, for example, the last location from which a geolocation and/or global positioning signal was transmitted from a from a worker's location transmitter. In some embodiments, the last known location of store workers may be estimated based on the most recent product scans performed by store workers using a handheld device assigned to each worker. In some embodiments, the last known or estimated locations of store workers may be stored, for example, in database 140. The system may compare the last known or estimated locations of the store workers and identify a store worker in proximity to the motion sensor and/or the one or more retail products.

In some embodiments, the location transmitter may be configured to emit a radio frequency identification (RFID) signal and the system may be configured to detect the RFID signal within a predetermined distance from one or more retail products. In such a case, the system may determine that a store worker is in proximity to the one or more retail products by associating the RFID signal with a specific store worker in the shopping area. For example, when a store worker approaches an area of the store having shelf inventory of one or more retail products, a motion sensor in proximity to the one or more retail products may detect motion of the approaching store worker and/or may detect an RFID signal being emitted from an RFID transmitter carried by the store worker. The system may correlate the RFID data with a specific store worker to determine that the store worker is in proximity to the motion sensor and/or the one or more retail products.

If the system determines that a store worker is in proximity to the motion sensor and/or the one or more retail products, in step 230 the system determines that a shelf inventory level of the one or more retail products is below a predetermined threshold. In some embodiments, the system may determine that the shelf inventory level of the one or more retail products is below the predetermined threshold by comparing data obtained from various inventory systems, which may be stored in a database, such as database 140. In some embodiments, the system may compare the number of retail products previously shelved to at least one of the number of retail products sold and the number of retail products in stock. For example, the system may obtain point of sale data for a specific retail item and determine that the number of units sold is approaching the number of units previously shelved for a specific time period. The system may also determine whether or not there is additional inventory available to replenish the shelf inventory.

In some embodiments, the system may obtain shelf inventory data from one or more shelf inventory sensors. The shelf inventory sensors may be located anywhere on a shelf or module upon which one or more retail items are displayed for purchase and may comprise any sensor capable of detecting and/or determining the shelf inventory level of the one or more retail products, such as, for example, load sensors and/or weight sensors. The system may determine that the shelf inventory level of the one or more retail products is below the predetermined threshold based on data obtained from the one or more shelf inventory sensors. In some embodiments, the system may obtain real time data regarding shelf inventory levels from the shelf inventory sensors. In some embodiments, shelf inventory data may be stored in a database, such as database 140 described with reference to FIG. 1.

If the system determines that the shelf inventory level is below the predetermined threshold, in step 240 the system may alert the store worker in proximity to the one or more retail products. In some embodiments, the system may cause an alerting device positioned adjacent to the one or more retail products to alert the store worker that the shelf inventory level of the one or more retail products is below the predetermined threshold. In some embodiments, the alerting device may comprise alerting device 170 described with reference to FIG. 1. The alerting device may comprise a lighting device configured to alert the store worker by displaying a light signal when the shelf inventory level of the one or more retail products is below the predetermined threshold. The lighting device may be configured to emit any color or wavelength of visible light when the shelf inventory is below the predetermined threshold. In some embodiments, the lighting device may emit different colors or wavelengths of light based on the estimated shelf inventory in proximity to the lighting device. For example, the lighting device may emit a yellow light when the shelf inventory is below the predetermined threshold and may emit red light when the shelf inventory has been completely depleted and/or when there is no additional inventory available to replenish the shelf inventory. In some embodiments, the lighting device may emit a continuous light when the shelf inventory is below the predetermined threshold. In other embodiments, the lighting device may emit a flashing light when the shelf inventory is below the predetermined threshold.

In some embodiments, the alerting device may comprise a handheld device configured to be carried by the store worker. The handheld device may comprise any mobile electronic device that may be carried by a store worker. For example, the handheld device may comprise a personal computer, a laptop computer, or a handheld communication device such as a mobile phone or tablet or the like. The handheld device may be configured to alert the store worker to the presence of low shelf inventory by emitting a continuous or flashing light in response to shelf inventory levels, as described above for the lighting device. In other embodiments, the handheld device may alert the worker by using an audio or vibrating alert. For example, the handheld device may be configured to emit a specific pattern of vibration or sound, or a specific audio tone and/or frequency to alert the store worker to the presence of low shelf inventory. In some embodiments, the handheld device may be configured to display a text message alerting the store worker to low shelf inventory levels. In some embodiments, the handheld device may be configured to display the actual or estimated shelf inventory level of one or more retail products having a shelf inventory level below the predetermined threshold and/or may display instructions for the store worker regarding how to respond. In some embodiments, the handheld device may include the location transmitter for transmitting the location of the store worker carrying the handheld device. For example, the handheld device may include both an alerting component and a geolocation and/or global positioning component that transmits the location of the handheld device to the system.

In addition to alerting the store worker, in some embodiments, the system may automatically create a task in a task scheduling system to replenish the shelf inventory level of the one or more retail products below having a shelf inventory level below the predetermined threshold.

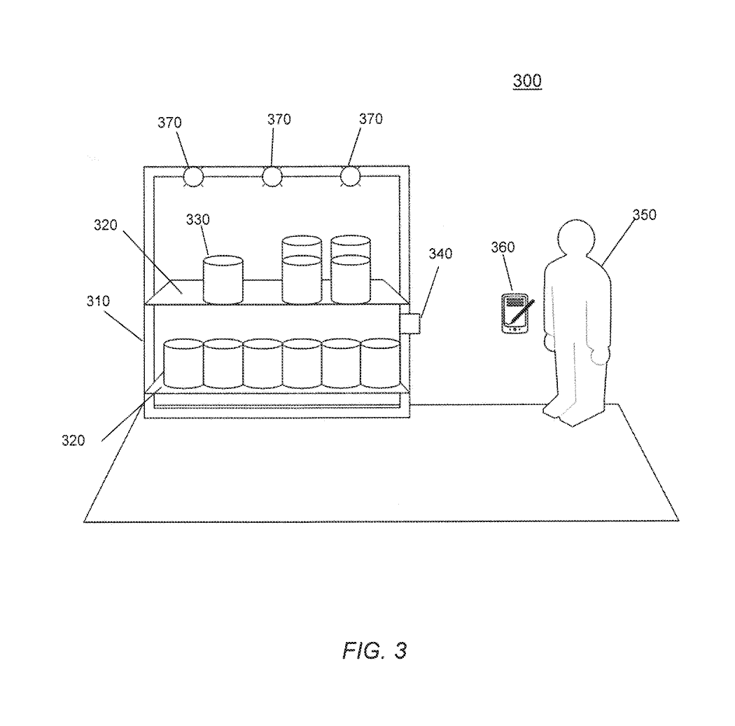

Next referring to FIG. 3, an illustration of a retail facility according to some embodiments is shown. The retail facility 300 may comprise a display module 310, which may include one or more shelves 320. Retail products 330 are displayed on the shelves 320. The lower shelf 320 illustrates a shelf having a full shelf inventory of retail products 330, while the upper shelf 320 illustrates a shelf having a reduced shelf inventory of retail products 330. Motion sensor 340 may be located on display module 310 in such a manner that it can detect the motion of a person in proximity to the retail products 330. One or more alerting devices 370 may be disposed on display module 310 and positioned to be visible by a passing store worker 350. It should be noted that the number and location of the alerting devices 370 and the motion sensor 340 are not limited to those displayed in FIG. 3. The number and location of alerting devices and motion sensors may be selected based on a variety of factors, such as, for example, the retailer's needs and the parameters of the retail facility.

As a person approaches motion sensor 340, the sensor detects the motion of the person and triggers the system to determine whether a store worker 350 is in proximity to the one or more retail products 330. The system may determine that a store worker 350 is in proximity to the one or more retail products 330 by obtaining last known locations of one or more store workers in the shopping area and identifying a store worker 350 having a last known location within a predetermined distance to at least one of the location of the motion sensor 340 and the location of the one or more retail products 330. In some embodiments, last known locations of store workers may comprise, for example, the last location from which a geolocation and/or global positioning signal was transmitted from a location transmitter in the store worker's handheld device 360. The handheld device 360 may comprise, for example, a personal computer, a laptop computer, or a handheld communication device such as a mobile phone or tablet or the like. In some embodiments, the last known or estimated location of store workers may be estimated based on the most recent product scans performed by store workers using a handheld device 360 assigned to each worker. In some embodiments, the location data may be stored in a database. The system may compare the last known or estimated locations of the store workers and identify a store worker 350 in proximity to the motion sensor 340 and/or the one or more retail products 330.

If the system determines that a store worker 350 is in proximity to the motion sensor 340 and/or the one or more retail products 330, the system determines whether a shelf inventory level of the one or more retail products 330 is below the predetermined threshold. In some embodiments, the system may determine that the shelf inventory level of the one or more retail products 330 is below the predetermined threshold by comparing data obtained from various inventory systems, which may be stored in a database. In some embodiments, the system may compare the number of retail products previously shelved to at least one of the number of retail products sold and the number of retail products in stock. For example, the system may obtain point of sale data for a specific retail product and determine that the number of units sold is approaching the number of units previously shelved for a specific time period. The system may also determine whether or not there is additional inventory available to replenish the shelf inventory.

In some embodiments, the system may obtain shelf inventory data from one or more shelf inventory sensors (not pictured). The shelf inventory sensors may be located anywhere on shelf 320 or display module 310 upon which one or more retail products 330 are displayed for purchase and may comprise any sensor capable of detecting and/or determining the shelf inventory level of the one or more retail products 330, such as, for example, load sensors and/or weight sensors. The system may determine that the shelf inventory level of the one or more retail products 330 is below the predetermined threshold based on data obtained from the one or more shelf inventory sensors. In some embodiments, the system may obtain real time data regarding shelf inventory levels from the shelf inventory sensors. In some embodiments, shelf inventory data may be stored in a database.

If the system determines that the shelf inventory level is below the predetermined threshold, the system may alert the store worker 350 in proximity to the one or more retail products 330. In some embodiments, the system may cause the alerting device 370 positioned adjacent to the one or more retail products 330 to alert the store worker 350 that the shelf inventory level of the one or more retail products 330 is below the predetermined threshold. The alerting device 370 may comprise a lighting device configured to alert the store worker by displaying a light signal when the shelf inventory level of the one or more retail products is below the predetermined threshold. The lighting device may be configured to emit any color or wavelength of visible light when the shelf inventory is below the predetermined threshold. In some embodiments, the lighting device may emit different colors or wavelengths of light based on the estimated shelf inventory in proximity to the lighting device. For example, the lighting device may emit a yellow light when the shelf inventory is below the predetermined threshold and may emit red light when the shelf inventory has been completely depleted and/or when there is no additional inventory available to replenish the shelf inventory. In some embodiments, the lighting device may emit a continuous light when the shelf inventory is below the predetermined threshold. In other embodiments, the lighting device may emit a flashing light when the shelf inventory is below the predetermined threshold.

In some embodiments, handheld device 360 may comprise an alerting component and may be configured to alert the store worker 350 to the presence of low shelf inventory by emitting a continuous or flashing light in response to shelf inventory levels. In other embodiments, the handheld device 360 may alert the worker by using an audio or vibrating alert. For example, the handheld device 360 may be configured to emit a specific pattern of vibration or sound, or a specific audio tone and/or frequency to alert the store worker to the presence of low shelf inventory. In some embodiments, the handheld device 360 may be configured to display a text message alerting the store worker 350 to low shelf inventory levels. In some embodiments, the handheld device 360 may be configured to display the actual or estimated shelf inventory level of one or more retail products 330 products having a shelf inventory level below the predetermined threshold and/or may display instructions for the store worker regarding how to respond.

In one embodiment, a system for inventory management in a retail facility comprises: a motion sensor positioned in a predetermined location in proximity to one or more retail products in a shopping area, the motion sensor configured to detect motion in proximity to the one or more retail products; a location transmitter for transmitting a location of a store worker; a database for storing at least one of inventory data, sales data, motion sensor data, location transmitter data, and store worker profiles; an alerting device for alerting the store worker to shelf inventory levels; and a control circuit coupled to the motion sensor, location transmitter, database, and alerting device, the control circuit configured to: determine that a store worker is in proximity to the one or more retail products; determine that a shelf inventory level of the one or more retail products is below a predetermined threshold; and cause the alerting device to alert the store worker in proximity to the one or more retail products that the shelf inventory level of the one or more retail products is below the predetermined threshold.

In one embodiment, a method of inventory management in a retail facility comprises: obtaining, by a motion sensor positioned in a predetermined location in proximity to one or more retail products in a shopping area, motion sensor data indicating detected motion in proximity to the one or more retail products; determining, using a control circuit, that a store worker is in proximity to the one or more retail products based on location data associated with one or more store workers in the shopping area; determining, using the control circuit, that a shelf inventory level of the one or more retail products is below a predetermined threshold; and alerting the store worker in proximity to the one or more retail products that the shelf inventory level of the one or more retail products is below the predetermined threshold.

It should be understood that each of the components of the system described herein may be in communication with one another using any conventional communications protocol, including wireless communication protocols. Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for inventory management, the system comprising:
a motion sensor positioned in a predetermined location in proximity to one or more retail products in a shopping area, the motion sensor configured to detect motion in proximity to the one or more retail products;
a location transmitter for transmitting a location of a store worker;
a database for storing at least one of inventory data, sales data, motion sensor data, location transmitter data, and store worker profiles;
an alerting device for alerting the store worker to shelf inventory levels; and
a control circuit coupled to the motion sensor, the location transmitter, the database, and the alerting device, the control circuit configured to:
determine that a store worker is in proximity to the one or more retail products;
determine that a shelf inventory level of the one or more retail products is below a predetermined threshold; and
cause the alerting device to alert the store worker in proximity to the one or more retail products that the shelf inventory level of the one or more retail products is below the predetermined threshold.

2. The system of claim 1, wherein the alerting device comprises a lighting device positioned at a location adjacent the one or more retail products, the lighting device configured to display a light signal when the shelf inventory level of the one or more retail products is below the predetermined threshold.

3. The system of claim 1, wherein the alerting device comprises a handheld device configured to be carried by the store worker.

4. The system of claim 3, wherein the handheld device is configured to display the shelf inventory level of the one or more retail products having a shelf inventory level below the predetermined threshold.

5. The system of claim 3, wherein the handheld device includes the location transmitter for transmitting the location of the store worker carrying the handheld device.

6. The system of claim 1, wherein the control circuit determines that the store worker is in proximity to the one or more retail products by:
obtaining last known locations of one or more store workers in the shopping area; and
identifying the store worker having a last known location within a predetermined distance to at least one of the location of the motion sensor and the location of the one or more retail products.

7. The system of claim 1, wherein the location transmitter is configured to emit a radio frequency identification (RFID) signal, the motion sensor is configured to detect an RFID signal and to transmit to the control circuit the RFID signal from a location transmitter that is within the predetermined distance to the motion sensor, and the control circuit determines that a store worker is in proximity to the one or more retail products by associating the RFID signal with the store worker.

8. The system of claim 1, further comprising one or more shelf inventory sensors for detecting the shelf inventory level of the one or more retail products, wherein the control circuit determines that the shelf inventory level of the one or more retail products is below the predetermined threshold based on data obtained from the one or more shelf inventory sensors.

9. The system of claim 1, wherein the control circuit determines that the shelf inventory level of the one or more retail products is below the predetermined threshold by comparing a number of retail products previously shelved to at least one of a number of retail products sold and a number of retail products in stock.

10. The system of claim 1, wherein the control circuit is further configured to automatically create a task in a task scheduling system to replenish the shelf inventory level of the one or more retail products below having a shelf inventory level below the predetermined threshold.

11. A method for inventory management, the method comprising:
obtaining, by a motion sensor positioned in a predetermined location in proximity to one or more retail products in a shopping area, motion sensor data indicating detected motion in proximity to the one or more retail products;
determining, using a control circuit, that a store worker is in proximity to the one or more retail products based on location data associated with one or more store workers in the shopping area;
determining, using the control circuit, that a shelf inventory level of the one or more retail products is below a predetermined threshold; and
alerting the store worker in proximity to the one or more retail products that the shelf inventory level of the one or more retail products is below the predetermined threshold.

12. The method of claim 11, wherein the store worker is alerted by a lighting device positioned at a location adjacent the one or more retail products, the lighting device configured to display a light signal when the shelf inventory level of the one or more retail products is below the predetermined threshold.

13. The method of claim 11, wherein the store worker is alerted by an alert from a handheld device configured to be carried by the store worker.

14. The method of claim 13, wherein the handheld device is configured to display the shelf inventory level of the one or more retail products having a shelf inventory level below the predetermined threshold.

15. The method of claim 13, wherein the handheld device includes a location transmitter for transmitting the location of the store worker carrying the handheld device.

16. The method of claim 11, wherein determining that the store worker is in proximity to the one or more retail products comprises:
obtaining last known locations of one or more store workers obtained in the shopping area; and
identifying the store worker having a last known location within a predetermined distance to at least one of the location of the motion sensor and the location of the one or more retail products.

17. The method of claim 11, wherein determining that the store worker is in proximity to the one or more retail products comprises:
obtaining a radio frequency identification (RFID) signal from a location transmitter associated with a store worker when the location transmitter is within a predetermined distance to the motion sensor; and
associating the RFID signal with the store worker.

18. The method of claim 11, wherein the shelf inventory level of the one or more retail products is determined to be below the predetermined threshold based on data obtained from one or more shelf inventory sensors positioned in proximity to the one or more retail products.

19. The method of claim 11, wherein the shelf inventory level of the one or more retail products is determined, by the control circuit, to be below the predetermined threshold by comparing a number of retail products previously shelved to a number of retail products sold and a number of retail products in stock.

20. The method of claim 11, further comprising automatically creating a task in a task scheduling system to replenish the shelf inventory level of the one or more retail products below the predetermined threshold.
